(19) United States
(12) Patent Application Publication
(10) Pub. No.: US 2005/0128091 A1
(43) Pub. Date: Jun. 16, 2005

(54) Apparatus and method for storing, transporting and providing emergency personnel with critical user specific information

(75) Inventor: Edward Ricci, Deposit, NY (US)

Correspondence Address: Breiner & Breiner, L.L.C., P.O. Box 19290, Alexandria, VA, 22320-0290, US

(73) Assignee: MEDICTAG, LLC, Deposit, NY (US)

(21) Appl. No.: 10/967,231

(22) Filed: Oct. 19, 2004

Related U.S. Application Data
(60) Provisional application No. 60/527,036, filed on Dec. 5, 2003.

(51) Int. Cl. G08B 23/00

(52) U.S. Cl. 340/573.1; 705/3

(57) ABSTRACT

A method and an apparatus for carrying medical and/or emergency information of a person so as to be readily available to emergency response personnel is disclosed. The apparatus has a memory device and a connector. The memory device is a portable storage device and the connector may be a USB interface or connector. More particularly, the apparatus is a keychain size USB flash memory device. The memory device is loaded with an appropriate software application or template and user specific emergency information is installed using that software application or template. When the memory device is plugged into a host computer, typically a hospital admission room computer or a mobile computer in an emergency vehicle, the software application is launched or the template is displayed. Consequently, emergency personnel are able to readily access an individual's emergency information.

### RELATED APPLICATIONS

This application hereby claims the benefit under 35 U.S.C. § 119(e) of U.S. Provisional Application Ser. No. 60/527,036 filed Dec. 5, 2003, entitled “An Apparatus and Method For Storing, Transporting and Providing Emergency Personnel With Critical User Specific Information.”

### FIELD OF THE INVENTION

The present invention relates to a method and apparatus for providing user specific information to emergency response personnel in a timely manner and more particularly to the use of a personal storage device for storing, transporting and accessing the user specific information.

### BACKGROUND OF THE INVENTION

People with known medical conditions, severe allergic reactions, taking certain medications or the like often wear special identification bracelets or tags which contain this medical information. Traditionally, the bracelets or tags display a universally recognized medical symbol to alert emergency response personnel to the person's unique medical needs. The small size of the bracelet or tag limits the information which it may contain to a few words or a telephone number to call for additional information. A wallet size card may also be carried by the person to provide some additional information, but again, due to size, the information which the card may contain is limited. Accordingly, access to specific medial information of a person being treated by emergency response personnel is often very limited or even unavailable at the time of treatment, especially in the field.

The prior methods and apparatus for alerting emergency personnel to a person's specific medical needs provide a very limited amount of information and requires critical time to be spent obtaining more information in the event of a debilitating illness or injury or an illness or injury which may become so if critical treatment time is spent trying to obtain a person's medical information. The method and apparatus of the present invention solves these and other problems associated with the prior methods and apparatus.

### OBJECTS AND SUMMARY OF THE INVENTION

The present invention is a method and apparatus for carrying emergency medical information of a person so that the information is readily available to emergency personnel. More particularly, the method and apparatus provide user specific emergency and/or medical information to emergency response personnel in a timely manner by utilizing a personal storage device (hereafter “PSD”) for storing, transporting and accessing the user specific emergency and/or medical information. The desired user specific information is stored on the PSD in a suitable digital format. The PSD may then be carried by the user in any suitable form. Upon need of the information, the PSD may be connected to a host computer to allow instant access to the stored information. The information may be formatted so as to be compatible with standard word processing applications and may be stored in any suitable format, again to achieve maximum compatibility. The information on the PSD may be selected by the use of a menu application. The menu application is any suitable menu which will allow a user to view, create, delete, add, edit or modify the user specific emergency information.

The case or shell of the PSD may be designed in numerous configurations which are convenient to the manufacturing process or preferred by the user.

A primary object of the method and apparatus of the present invention is to alert emergency response personnel to the presence of user specific emergency and/or medical information.

Another object of the method and apparatus of the present invention is to have a person's emergency and/or medical information easily and quickly available to emergency or medical personnel.

Another object of the method and apparatus of the present invention is to provide a convenient method for an individual to carry his/her personal emergency and/or medical information on or with his/her person.

Further objects, features and benefits of the present invention will be readily apparent to those skilled in the art based upon this disclosure.

### BRIEF DESCRIPTION OF THE DRAWINGS

Referring to the drawings:

FIG. 1 shows a memory device such as a PSD of the present invention utilizing a USB connector for connection to a host computer.

FIG. 2 shows the memory device of FIG. 1 in a case and utilizing a USB connector for connection to a host computer.

### DETAILED DESCRIPTION OF THE PREFERRED EMBODIMENTS

The present invention is a method and apparatus for carrying emergency and/or medical information of a person so that the information is readily available to emergency personnel. More particularly, the method and apparatus provides user specific emergency and/or medical information to emergency response personnel in a timely manner by utilizing a PSD for storing, transporting and accessing the user specific emergency and/or medical information. The required user specific information is inputted and stored on the PSD in a suitable digital format. The PSD may then be carried by the user in any suitable form such as a bracelet, a necklace, a tag on a keychain or the like. Upon need of the information, the PSD may be connected to a host computer to allow instant access to the stored information. The information may be formatted so as to be compatible with standard word processing applications and may be stored in any suitable format such as in Microsoft® Word or Adobe® PDF document format, again to achieve maximum compatibility. The information may be selected by the use of a suitable menu application which allows a user to view, create, delete, add, edit or modify the user specific emergency information.

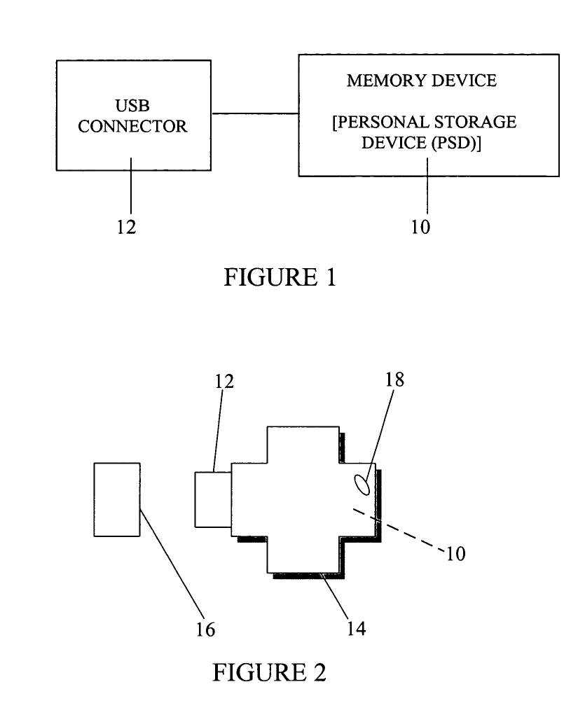

Presently, computer technology favors the Universal Serial Bus (hereafter “USB”) connection and most manufacturers provide several on new computers. Therefore, in order to achieve maximum compatibility, the preferred embodiment of the PSD 10 of the present invention uses a USB connector 12 for its connection to a host computer, as shown in FIGS. 1 and 2. The USB connector 12 is preferably connected to the host computer by a USB port on the host computer. When the USB connector, i.e., drive, is plugged into the host computer, typically a hospital admission room computer or a mobile computer in an emergency vehicle, a software application is launched or a template is displayed. Consequently, emergency personnel are able to readily access an individual's emergency information.

In a preferred embodiment, the PSD 10 is a flash memory storage device which may also have a USB interface/connector 12. In another preferred embodiment, the PSD 10 is a removable hard disc which may also have a USB interface/connector 12.

The user specific emergency medical information stored on the PSD may be any general and/or specific medical information of the user. This information may include general information about the user such as name, address, telephone number, birth date, age, gender, physician's name, physician's telephone number or the like. The PSD may also include information such as the user's emergency contact information, insurance information, prescription drugs and over-the-counter drugs, allergies to medications, medical history, medical problems, previous surgeries, any other medical information or the like.

In a preferred embodiment, the user may also be able to access the MEDICTAG™ website and e-mail address when the PSD 10 is connected to the host computer. The MEDICTAG™ website may provide the user with information such as how to use the PSD, general information about MEDICTAG™, product and purchase information, frequently asked questions, software downloads, contact information for MEDICTAG™ and the like.

The case 14 or shell which houses the memory device such as the PSD 10 may be designed in numerous configurations which are convenient to the manufacturing process or preferred by the user. The PSD 10 and case 14 may be any suitable size and shape. The case 14 which houses the PSD 10 is preferably small in size such as pocket size or smaller and may be in various forms including, but not limited to, a keychain, a bracelet, a necklace and the like. As shown in FIG. 2, the case 14 may have a protective cover 16, which is preferably removable, for covering the USB connector 12. The case 14 may also have an attachment point 18 whereby a chain, necklace, string, key ring or the like may be affixed or attached to the case 16 for ease of wearing and/or transporting by the user.

A preferred embodiment of the PSD 10 preferably bears a symbol familiar to or easily recognized by medical and other emergency response personnel. This allows the emergency response personnel to quickly identify the person's PSD so that they may access the person's medical and/or emergency information while treating the person. In a preferred embodiment, the case or shell itself may be manufactured in such a manner as to represent this symbol or to display this symbol.

Persons benefitting from the present invention include a broad spectrum of society such as, but not limited to, motor vehicle operators, elderly, infirm or ill persons, children and the like.

The method of the present invention comprises processing and providing medical and/or emergency information of a person to emergency response personnel. The method comprises inputting predetermined individual specific medical and/or emergency information into a host computer or into the PSD via a host computer by any suitable means known in the art. This medical and/or emergency information is then stored in a suitable PSD, such as, but not limited to, a flash memory storage device, a removable hard disc or the like, and in a suitable document format. When the medical and/or emergency information is needed by a medical or emergency response personnel or the like, the PSD is connected to a host computer, preferably by a USB interface/connector into a USB port on the host computer. However, any suitable connecting mechanism or interface may be used. The predetermined individual specific information is then retrieved from the PSD and provided to the medical or emergency response personnel. This medical and/or emergency information will then aid the medical or emergency response personnel in treating the person.

The method may also comprise updating the medical and/or emergency information of the user to create, add, delete, edit or modify the user's specific medical and/or emergency information by any suitable person including, but not limited to, doctors, nurses, paramedics, the user and the like.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A method of processing and providing emergency information of at least one person by a host computer comprising:
(a) inputting predetermined individual specific emergency information into a portable storage device;
(b) storing said predetermined individual specific emergency information in said portable storage device;
(c) connecting said portable storage device to said host computer; and
(d) providing said predetermined individual specific emergency information to medical or emergency response personnel.

2. The method of claim 1, further comprising repeating (a) through (d) as required.

3. The method of claim 1, wherein said portable storage device is a flash memory storage device.

4. The method of claim 1, wherein said portable storage device is a flash memory storage device with a USB interface or connector.

5. The method of claim 1, wherein said portable storage device is a removable hard disc.

6. The method of claim 1, wherein said portable storage device is a removable hard disc with a USB interface or connector.

7. The method of claim 1, wherein the said emergency information is formatted so as to be compatible with standard word processing applications.

8. The method of claim 1, wherein said emergency information is formatted utilizing a portable document format.

9. The method of claim 1, wherein said emergency information is provided through use of a menu application.

10. A device for processing and providing emergency information of at least one person by a host computer comprising:
a memory device capable of having predetermined individual specific emergency information of said at least one person stored thereon;
a connector attached to said memory device for connecting said memory device to said host computer for accessing said emergency information.

11. The device of claim 10, wherein said memory device is a portable storage device.

12. The device of claim 11, wherein said portable storage device is a flash memory storage device.

13. The device of claim 11, wherein said portable storage device is a flash memory storage device with a USB interface or connector.

14. The device of claim 11, wherein said portable storage device is a removable hard disc.

15. The device of claim 11, wherein said portable storage device is a removable hard disc with a USB interface or connector.

16. The device of claim 10, wherein the said emergency information is formatted so as to be compatible with standard word processing applications.
